(19) United States
(12) Patent Application Publication
(10) Pub. No.: US 2016/0001609 A1
(43) Pub. Date: Jan. 7, 2016

(54) Bead of a Tire For a Heavy Vehicle Of Construction Plant Type

(71) Applicants: COMPAGNIE GENERALE DES ETABLISSEMENTS MICHELIN, Clermont-Ferrand (FR); MICHELIN RECHERCHE ET TECHNIQUE S.A., Granges-Paccot (CH)

(72) Inventor: Athanase KOLLIAS, Clermont-Ferrand-Cedex 9 (FR)

(21) Appl. No.: 14/412,373

(22) PCT Filed: Jul. 1, 2013
(86) PCT No.: PCT/EP2013/063779

§ 371 Date: Dec. 31, 2014

(30) Foreign Application Priority Data
Jul. 4, 2012 (FR) 1256417

(51) Int. Cl. B60C 15/06; B60C 15/00; B60C 9/08

(52) U.S. Cl. CPC B60C 15/0603; B60C 9/08; B60C 15/0009; B60C 2001/0058

(57) ABSTRACT

Radial tire for heavy vehicle comprises carcass layer (3) comprising main part (31) wrapped, in each bead (1), from inside to outside of the tire, around bead wire (4), to form turn-up (32). Distance (d) between turn-up (32) and main part (31) decreases continuously, radially towards the outside, from bead wire (4), and passes through minimum value (d1). Carcass layer (3) has parallel reinforcers coated in coating compound (33), and filling element (5) extending axially between turn-up (32) and main part (31) and radially outwards from bead wire (4). Filling element (5) comprises two filling compounds (51, 52) extending radially outwards from bead wire (4). Compound (51) has a modulus of elasticity at 10% elongation at least equal to the modulus of elasticity of the second (52), which has a modulus of elasticity at 10% elongation equal to the modulus of elasticity at 10% elongation of coating compound (33).

The present invention relates to a radial tire intended to be fitted to a heavy vehicle of construction plant type.

Although not restricted to this type of application, the invention will be more particularly described with reference to a radial tire of large size intended to be mounted, for example, on a dumper, a vehicle for transporting materials extracted from quarries or open cast mines. The nominal diameter of the rim of such a tire, within the meaning of the European Tire and Rim Technical Organisation (ETRTO) standard, is at least equal to 25 inches.

A tire comprises two beads which provide the mechanical connection between the tire and the rim on which it is mounted, the beads being joined respectively by two sidewalls to a tread intended to come into contact with the ground via a tread surface.

In what follows, the circumferential, axial and radial directions respectively denote a direction tangential to the tread surface in the direction of rotation of the tire, a direction parallel to the axis of rotation of the tire and a direction perpendicular to the axis of rotation of the tire. “Radially on the inside, or respectively radially on the outside” means “closer to or, respectively, further away from the axis of rotation of the tire”. “Axially on the inside or, respectively, axially on the outside” means “closer to or, respectively, further away from the equatorial plane of the tire”, the equatorial plane of the tire being the plane that passes through the middle of the tread surface of the tire and perpendicular to the axis of rotation of the tire.

A radial tire more particularly comprises a reinforcement, comprising a crown reinforcement, radially on the inside of the tread, and a carcass reinforcement, radially on the inside of the crown reinforcement.

The carcass reinforcement of a radial tire for a heavy vehicle of construction plant type usually comprises at least one carcass layer made up of generally metallic reinforcers coated in a coating compound. The carcass layer comprises a main part, joining the two beads together and wrapped, in each bead, from the inside of the tire to the outside around a bead wire so as to form a turn-up. The metallic reinforcers are substantially parallel to one another and make, with the circumferential direction, an angle of between 85° and 95° in the case of the main part, and an angle of between 75° and 105° in the case of the turn-up.

The bead wire is made up of a generally metallic circumferential reinforcing element surrounded by at least one material, which, and this list is not exhaustive, may be made of polymer or textile. The portion of bead wire in contact with the carcass reinforcement contributes to reacting tensile forces in the carcass reinforcement upon inflation, by coupling with the carcass reinforcement. This contribution towards reacting tensile forces is dependent on the torsional stiffness of the bead wire and on the length of the turn-up. In the usual case in which the bead wire has high torsional stiffness, the tensile forces on inflation are essentially reacted by the bead wire, with the turn-up making a secondary contribution.

The turn-up, in each bead, allows the carcass layer to be anchored to the bead wire of the bead. In the case of a tire for a heavy vehicle of construction plant type, the turn-up is generally long, which means to say that its free end is radially closer to the axially outermost point of the carcass reinforcement in the sidewall of the tire than it is to the axially outermost point of the bead wire.

Each bead also comprises a filling element which extends the bead wire radially outwards and has a substantially triangular shape. The filling element is made from at least one filling compound, and frequently made of a stack, in the radial direction, of at least two filling compounds with different chemical compositions. In the field of tires, “compound” is the name given to a polymer material usually obtained by compounding the components of the material. Moreover, the filling element axially separates the main part from the turn-up.

A compound, after curing, is mechanically characterized by tensile stress-deformation characteristics which are determined by tensile testing. This tensile testing is carried out by a person skilled in the art, on a test specimen, according to a known method, for example in accordance with international standard ISO 37, and under standard temperature (23+ or −2° C.) and moisture (50 + or −5% relative humidity) conditions defined by International Standard ISO 471. For a compound, the modulus of elasticity at 10% elongation, expressed in megapascals (MPa), is the tensile stress measured for a 10% elongation of the test specimen.

A compound, after curing, is also mechanically characterized by its hardness. The hardness is notably defined by the Shore A hardness determined in accordance with standard ASTM D 2240-86.

When the vehicle is being driven along, the tire, mounted on its rim, inflated and compressed under the load of the vehicle, is subjected to bending cycles, particularly in its beads and its sidewalls.

The bending cycles lead in particular to stresses and deformations, mainly in shear and in compression, in the filling material compounds, because of the bending of the bead on the rim flange.

Document EP 2216189 describes a tire bead the endurance of which is improved by reducing the compressive deformations in the turn-up when the bead bends on the rim when in use. This objective is achieved by a turn-up which is such that the distance between the turn-up and the main part decreases continuously, radially towards the outside, from the bead wire, as far as a minimum distance and then increases continuously as far as a maximum distance. The turn-up extends radially on the outside of that point of the turn-up that corresponds to the maximum distance between the turn-up and the main part.

Document JP 2010274862 also describes a tire bead having improved endurance, when the bead bends on the rim when in use, in the case of a bead, as described in document EP 2216189, having a turn-up such that the distance between the turn-up and the main part decreases continuously, radially towards the outside, from the bead wire, as far as a minimum distance and then increases continuously as far as a maximum distance. This objective is achieved by the presence of a filling element between the main part and the turn-up, comprising a first, hard compound that extends radially outwards from the bead wire, and a second filling compound that extends radially outwards from the first, hard compound. The second filling compound is present at least in part in the region where the distance between the main part and the turn-up is at a minimum. This design makes it possible to reduce the shear forces in this region and thus to further improve the endurance of the bead.

The inventors have set themselves the objective of further improving the endurance of the beads of a radial tire for a heavy vehicle of construction plant type.

This objective has been achieved, according to the invention, by a tire for a heavy vehicle of construction plant type, comprising:

two beads intended to come into contact with a rim,

a carcass reinforcement comprising at least one carcass layer comprising a main part wrapped, in each bead, from the inside of the tire to the outside, around a bead wire with an approximately circular meridian section of diameter D, so as to form a turn-up,

the distance between the turn-up and the main part decreasing continuously, radially towards the outside, from the bead wire, and passing through a minimum value,

the carcass layer being made up of mutually parallel reinforcers that are coated in a coating compound,

a filling element extending axially between the turn-up and the main part and radially outwards from the bead wire,

the filling element comprising at least two filling compounds,

a first filling compound extending radially outwards from the bead wire,

the first filling compound having a modulus of elasticity at 10% elongation at least equal to the modulus of elasticity at 10% elongation of a second filling compound,

the second filling compound extending, radially outwards, from the bead wire, along the turn-up, at least as far as that point of the turn-up that is positioned at the minimum distance from the main part, and extending axially outwards, at least in part, from the first filling compound,

and the modulus of elasticity at 10% elongation of the second filling compound being equal to the modulus of elasticity at 10% elongation of the coating compound.

According to the invention, the second filling compound extends radially outwards, from the bead wire, along the turn-up and, at least in part, axially outwards, from the first filling compound: it is necessarily, at least in part, compressed axially between the turn-up and the first filling compound. In other words, the second filling compound is interposed, at least in part, between the coating compound for the reinforcers of the turn-up and the first filling compound. In addition, the second filling compound extends radially at least as far as that point of the turn-up that is positioned at the minimum distance from the main part. This means that the second filling compound is present in the narrowing region between the turn-up and the main part.

Besides the presence of the second filling compound, along the turn-up, from the bead wire to the narrowing region between the turn-up and the main part, another essential feature of the invention is that the modulus of elasticity at 10% elongation of the second filling compound is equal to the modulus of elasticity at 10% elongation of the coating compound.

The region of contact between the turn-up, or more specifically the coating compound for the reinforcers of the turn-up, and the filling element, close to the radially outermost point of the bead wire, is sensitive to the delamination caused by the high mechanical stresses in this region on account of the cyclic bending of the beads on the rim flanges.

Since the second filling compound has a modulus of elasticity equal to that of the coating compound with which it is in contact, there is no stiffness gradient at the interface between the second filling compound and the coating compound: hence there is desensitization to delamination in this region of contact.

In addition, given that the first filling compound has a modulus of elasticity at 10% elongation at least equal to the modulus of elasticity at 10% elongation of a second filling compound, the moduli of elasticity, and thus the stiffnesses, of the materials decrease from the main part to the turn-up. This contributes to a progressive evolution in the stresses between the main part and the turn-up.

Preferably, the second filling compound has the same chemical composition as the coating compound. The cohesion of the interface between the two materials is further improved as a result of their chemical compositions being identical.

It is advantageous for the axial distance between the first filling compound and the turn-up, measured along the axial straight line passing through the radially outermost point of the bead wire, to be at least equal to 0.15 times the diameter D of the bead wire. In other words, the thickness of the second filling compound at the radially outermost point of the bead wire must have a minimum value. The necessity of such a minimum thickness is imposed by the manufacturing process which has, as technological limit, a minimum thickness of the compound. In addition, such a minimum thickness value is necessary in order to obtain significant staging of the stiffnesses between the main part and the turn-up.

According to another embodiment, the radially outermost point of the first filling compound, in contact with the main part, is radially on the inside of that point of the turn-up that is positioned at the minimum distance from the main part. This configuration means that the first filling compound having a high modulus of elasticity is not present in the region of minimum distance between the turn-up and the main part or the region of minimum thickness of the filling element. In other words, the region of minimum thickness of the filling element is entirely filled with the second filling compound having a lower modulus of elasticity close to that of the coating compound. The resulting low gradient of stiffnesses, in this region of minimum thickness that is subjected to high shear stresses, improves the mechanical integrity of said region.

It is advantageous for the radial distance between that point of the turn-up that is positioned at the minimum distance from the main part and the radially innermost point of the bead wire to be at least equal to 1.5 times the diameter of the bead wire. This feature means that the region of minimum thickness of the filling element has to be at a sufficient radial distance from the bead wire so as to avoid excessive bending, at the start of this region, of the reinforcers of the turn-up: this would be detrimental to the fatigue strength of said reinforcers and would thus penalize the endurance of the bead.

Also advantageously, the radial distance between that point of the turn-up that is positioned at the minimum distance from the main part and the radially innermost point of the bead wire is at most equal to 4 times the diameter D of the bead wire. This feature means that the region of minimum thickness of the filling element has to be at a radial distance from the bead wire that is not excessive so as to avoid the reinforcers of the turn-up being placed under compression: this would be detrimental to the fatigue strength of said reinforcers and would thus penalize the endurance of the bead.

According to a preferred embodiment, the distance between the turn-up and the main part increases continuously, radially towards the outside, from that point of the turn-up that is positioned at the minimum distance from the main part and passes through a maximum distance between the turn-up and the main part. Once it has reached a minimum value, the distance between the turn-up and the main part increases continuously, radially towards to the outside, until it reaches a maximum value that is not necessarily reached at the end of the turn-up. Generally, but not necessarily, radially on the outside of that point of the turn-up at which this maximum distance is reached, the distance between the turn-up and the main part decreases again as far as the end of the turn-up. The presence of this maximum value causes a widening of the filling element, thereby allowing the reinforcers of the turn-up to be tensioned when the bead bends on the rim flange. This tensioning thus reduces the risk of the reinforcers of the turn-up entering into compression, this being favourable to the fatigue strength of said reinforcers and thus to the endurance of the bead.

According to another preferred embodiment, the distance between the turn-up and the main part is substantially equal to a constant value, radially towards the outside, from that point of the turn-up that is positioned at the minimum distance from the main part, over at least a portion of the turn-up. “Substantially constant” means that this distance may vary substantially between 0.9 times and 1.1 times the minimum distance. The portion of turn-up for which the distance between the turn-up and the main part is substantially equal to a constant value corresponds to the portion of bead that wraps around the rim flange, and, more specifically, around the substantially circular and radially outer portion of the rim flange when the tire is being driven on. In this portion of bead, which behaves in bending like a beam, the main part, which can be likened to the exterior axis of the beam, is in extension, whereas the turn-up, which can be likened to the interior axis of the beam, is in compression. Reducing the distance between the turn-up and the main part is equivalent to reducing the distance between the exterior and interior axes of the beam, and this makes it possible to reduce the extent to which the interior axis, i.e. the turn-up, is placed under compression. As seen above, this minimization or this absence of compression of the reinforcers of the turn-up is favourable to the endurance of the bead.

Finally, it is advantageous for the radial distance between the radially outermost point of the turn-up and the radially innermost point of the bead wire to be at least equal to 0.8 times the radial distance between the axially outermost point of the main part and the radially innermost point of the bead wire. In other words, the radial position of the end of the turn-up is close to that of the axially outermost point of the main part, this point, at which the tangent to the main part is radial, defining the width of the tire at the sidewall. This radial position of the end of the turn-up is characteristic of what is known as a long turn-up. A long turn-up contributes to reacting tensile forces in the carcass reinforcement layer upon inflation, provided that the torsional stiffness of the bead wire is sufficiently low. Depending on whether the end of the turn-up is positioned radially on the inside or radially on the outside of the axially outermost point of the carcass reinforcement, as the sidewall flexes under driving conditions, the end of the turn-up may be either pulled radially towards the outside and placed under tension or, on the other hand, be pushed radially inwards and placed under compression. The radial position of the end of the turn-up therefore governs whether or not the turn-up is placed under compression.

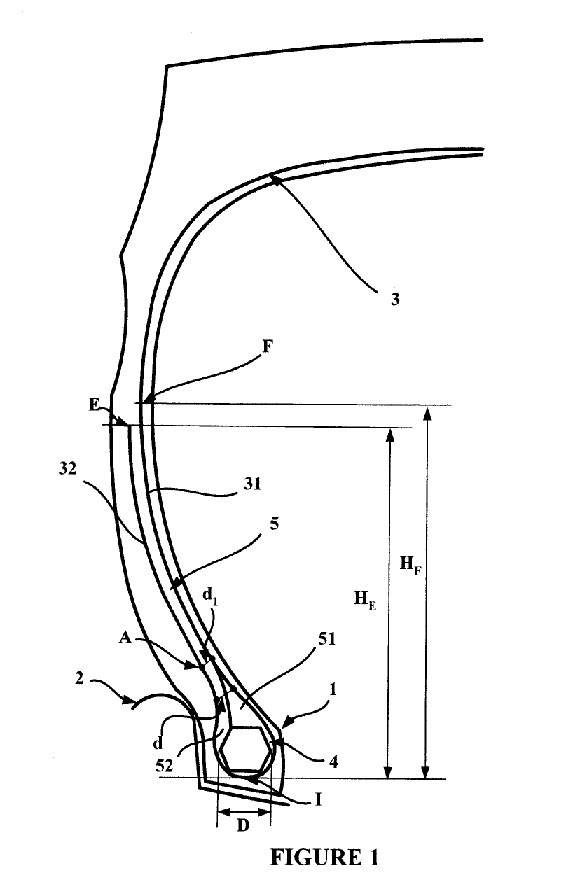

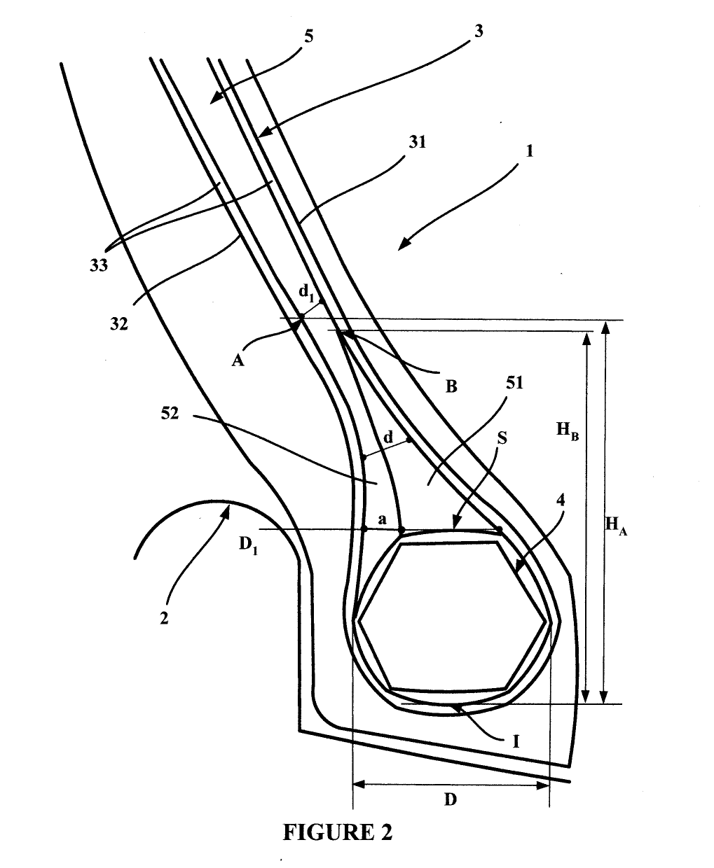

The features of the invention will be better understood with the aid of the description of the attached FIGS. 1 and 2, which are simplified depictions not shown to scale:

FIG. 1 is a half view in section, on a meridian plane, of a tire for a heavy vehicle of construction plant type, according to the invention.

FIG. 2 is a view in section, on a meridian plane, of the bead of a tire for a heavy vehicle of construction plant type, according to the invention.

FIG. 1 shows a tire for a heavy vehicle of construction plant type, comprising two beads 1 (only one of which is shown) that are intended to come into contact with a rim 2. The tire comprises a carcass reinforcement comprising a single carcass layer 3 comprising a main part 31 wrapped, in the bead 1, from the inside of the tire to the outside around a bead wire 4 with a hexagonal meridian section, inscribed in a circle of diameter D, so as to form a turn-up 32. The distance d between the turn-up 32 and the main part 31, measured perpendicularly to the turn-up 32, decreases continuously, radially towards the outside, from the bead wire 4, and passes through a minimum value d₁. The carcass layer 3 is made up of mutually parallel reinforcers (not shown) that are coated in a coating compound. A filling element 5 extends axially between the turn-up 32 and the main part 31 and radially outwards from the bead wire 4. The filling element 5 comprises two filling compounds (51, 52). A first filling compound 51 extends radially outwards from the bead wire 4. A second filling compound 52 extends, radially outwards, from the bead wire 4, along the turn-up 32, beyond that point A of the turn-up 32 that is positioned at the minimum distance d₁ from the main part 31, and extends axially outwards, at least in part, from the first filling compound 51, Also shown in FIG. 1 are the radial distance H_{E} between the radially outermost point E of the turn-up 32 and the radially innermost point I of the bead wire 4, and also the radial distance H_{F} between the axially outermost point F of the main part 31 and the radially innermost point I of the bead wire 4. The ratio H_{E}/H_{F} characterizes the relative length of the turn-up 32. In the present case, what is known as a long turn-up 32 is shown.

FIG. 2 shows a detailed view in section of a bead 1 according to the invention. In addition to the elements already described in FIG. 1, the carcass layer 3 is shown no longer as a line but as a thickness, revealing the coating compound 33 in which the reinforcers (not shown) of the carcass layer are coated. The thickness of the second filling compound 52, in the vicinity of the top part of the bead wire 4, is characterized by the axial distance a between the first filling compound 51 and the turn-up 32, measured along the axial straight line D₁ passing through the radially outermost point S of the bead wire 4. FIG. 2 also shows a preferred embodiment, in which the radially outermost point B of the first filling compound 51, in contact with the main part 31, is radially on the inside of that point A of the turn-up 32 that is positioned at the minimum distance d₁ from the main part 31. In other words, the radial distance H_{A} between that point A of the turn-up 32 that is positioned at the minimum distance d₁ from the main part 31 and the radially innermost point I of the bead wire 4 is greater than the radial distance H_{B} between the radially outermost point B of the first filling compound 51, in contact with the main part 31, and the radially innermost point I of the bead wire 4.

The invention has been studied in particular in the case of a tire for a large dumper of size 59/80R63, having a long turn-up, characterized by a radial distance H_{E} equal to 57 cm compared with a radial distance H_{F} equal to 60 cm. The bead wire 4 of the tire has a diameter D equal to 9 cm. The filling element 5 comprises a first and a second filling compound (51, 52), of which the respective moduli of elasticity at 10% elongation are equal to 9.5 MPa and 6 MPa, the second filling compound 52 and the coating compound 33 having identical chemical compositions. As far as the thickness of the second filling compound 52 is concerned, the axial distance a between the first filling compound 51 and the turn-up 32, measured along the axial straight line D₁ passing through the radially outermost point S of the bead wire 4, is equal to 2 cm, and thus greater than 0.15 times and less then 0.3 times the diameter D of the bead wire. The radial distance H_{B} between the radially outermost point B of the first filling compound 51, in contact with the main part 31, and the radially innermost point I of the bead wire 4 is equal to 19 cm. The radial distance H_{A} between that point A of the turn-up 32 that is positioned at the minimum distance d₁ from the main part 31, equal to 1.5 cm, and the radially innermost point I of the bead wire 4 is equal to 20 cm. Radially on the outside of the point A, the distance d remains substantially constant at the minimum value d₁, equal to 1.5 cm, over a portion of turn-up having a length of 5 cm, and then increases again, passing through a maximum value equal to 2.5 cm.

Simulations of finite-element calculations, carried out on a tire according to the invention, have shown that the delamination at the interface between the coating compound and the second filling compound, in the vicinity of the top part of the bead wire, was delayed compared with the reference tire.

The invention may be extended to other configurations of bead, comprising, for example, although this list is not exhaustive:

a second filling compound having a modulus of elasticity at 10% elongation that is not strictly equal to the modulus of elasticity at 10% elongation of the coating compound, but close to the latter, for example at least equal to 0.75 times and at most equal to 1.25 times the modulus of elasticity at 10% elongation of the coating compound,

one or more filling compounds that are axially interposed between the first and second filling compounds,

a radial stack of more than two filling compounds.

1. A tire for a heavy vehicle of construction plant type, comprising:
two beads configured to come into contact with a rim;
a carcass reinforcement comprising at least one carcass layer comprising a main part wrapped, in each bead, from the inside of the tire to the outside, around a bead wire with an approximately circular meridian section of diameter D, so as to form a turn-up;
the distance (d) between the turn-up and the main part decreasing continuously, radially towards the outside, from the bead wire, and passing through a minimum value (d₁);
the carcass layer being made up of mutually parallel reinforcers that are coated in a coating compound;
a filling element extending axially between the turn-up and the main part and radially outwards from the bead wire;
the filling element comprising at least two filling compounds;
a first filling compound extending radially outwards from the bead wire;
the first filling compound having a modulus of elasticity at 10% elongation at least equal to the modulus of elasticity at 10% elongation of a second filling compound;
wherein the second filling compound extends, radially outwards, from the bead wire, along the turn-up, at least as far as that point (A) of the turn-up that is positioned at the minimum distance (d₁) from the main part, and extends axially outwards, at least in part, from the first filling compound, and
wherein the modulus of elasticity at 10% elongation of the second filling compound is equal to the modulus of elasticity at 10% elongation of the coating compound.

2. The tire for a heavy vehicle of construction plant type according to claim 1, wherein the second filling compound has the same chemical composition as the coating compound.

3. The tire for a heavy vehicle of construction plant type according to claim 1, wherein the axial distance (A) between the first filling compound and the turn-up, measured along the axial straight line (D₁) passing through the radially outermost point (S) of the bead wire, is at least equal to 0.15 times the diameter D of the bead wire.

4. The tire for a heavy vehicle of construction plant type according to claim 1, wherein the axial distance (A) between the first filling compound and the turn-up, measured along the axial straight line (D₁) passing through the radially outermost point (S) of the bead wire, is at most equal to 0.5 times the diameter D of the bead wire.

5. The tire for a heavy vehicle of construction plant type according to claim 1, wherein the radially outermost point (B) of the first filling compound, in contact with the main part, is radially on the inside of that point (A) of the turn-up that is positioned at the minimum distance (d1) from the main part.

6. The tire for a heavy vehicle of construction plant type according to claim 1, wherein the radial distance (H_{A}) between that point (A) of the turn-up that is positioned at the minimum distance (d₁) from the main part and the radially innermost point (I) of the bead wire is at least equal to 1.5 times the diameter D of the bead wire.

7. The tire for a heavy vehicle of construction plant type according to claim 1, wherein the radial distance (H_{A}) between that point (A) of the turn-up that is positioned at the minimum distance (d₁) from the main part and the radially innermost point (I) of the bead wire is at most equal to 4 times the diameter D of the bead wire.

8. The tire for a heavy vehicle of construction plant type according to claim 1, wherein the distance (d) between the turn-up and the main part increases continuously, radially towards the outside, from that point (A) of the turn-up that is positioned at the minimum distance (d₁) from the main part and passes through a maximum distance between the turn-up and the main part.

9. The tire for a heavy vehicle of construction plant type according to claim 1, wherein the distance (d) between the turn-up and the main part is equal to a constant value, radially towards the outside, from that point (A) of the turn-up that is positioned at the minimum distance (d₁) from the main part, over at least a portion of the turn-up.

10. The tire for a heavy vehicle of construction plant type according to claim 1, wherein the radial distance (H_{E}) between the radially outermost point (E) of the turn-up and the radially innermost point (I) of the bead wire is at least equal to 0.8 times the radial distance (H_{F}) between the axially outermost point (F) of the main part and the radially innermost point (I) of the bead wire.

11. The tire for a heavy vehicle of construction plant type according to claim 1, wherein the axial distance between the first filling compound and the turn-up, measured along the axial straight line passing through the radially outermost point of the bead wire, is at most equal to 0.3 times the diameter D of the bead wire.
